(19) United States
(12) Patent Application Publication
(10) Pub. No.: US 2011/0072821 A1
(43) Pub. Date: Mar. 31, 2011

(54) Control Device and Method for a Quick-Acting Gate Valve of a Steam Turbine

(75) Inventors: Christian Potten, Voerde (DE); Holger Hennecke, Hemer (DE)

(73) Assignee: MAN Diesel & Turbo SE, Augsburg (DE)

(21) Appl. No.: 12/993,944

(22) PCT Filed: May 19, 2009
(86) PCT No.: PCT/EP2009/003585

§ 371 Date: Nov. 22, 2010

(30) Foreign Application Priority Data
May 20, 2008 (DE) 10 2008 024 253.5

(51) Int. Cl. F01D 21/00; F16K 15/00; G01M 15/00

(52) U.S. Cl. 60/657; 137/455; 73/112.02

(57) ABSTRACT

A control device for a quick-closing valve of a steam turbine including a relief valve for reducing a hydraulic pressure opening the quick-closing valve, and a relief valve control valve arrangement having at least three valves which are hydraulically interconnected with the relief valve in such a way that the relief valve does not close the quick-closing valve unless at least two valves of the relief valve control valve arrangement are switched to a quick-closing position. The system includes a test control valve arrangement for selectively reducing and increasing the hydraulic pressure opening the quick-closing valve when the relief valve is closed.

### PRIORITY CLAIM

This is a U.S. national stage of Application No. PCT/EP2009/003585, filed on May 19, 2009, which claims priority to German Application No: 10 2008 024 253.5, filed: May 20, 2008, the contents of which are incorporated herein by reference.

### BACKGROUND OF THE INVENTION

1. Field of the Invention

The invention is directed to a control device for a quick-closing valve of a steam turbine with a relief valve for closing the quick-closing valve and a 2-out-of-3-voting relief valve control valve arrangement, a quick-closing valve for a steam turbine with a control device of this kind, and a method for conducting a partial stroke test for a quick-closing valve of this kind.

2. Related Art

Steam turbines in which live steam from a boiler is expanded and, in so doing, drives one or more turbine stages, may not exceed determined maximum speeds to prevent damage to turbine components. To prevent the turbine from exceeding this maximum speed during load shedding, coupling breakage, or the like, it is known from DE 10 2004 042 891 B3 to provide a quick-closing valve that interrupts or reduces the mass flow of steam to the turbine in the shortest possible time, when the turbine speed exceeds a predetermined threshold or when it is recognized in some other way that exceeding of the maximum speed is imminent.

Consequently, quick-closing valves of this type and the actuation thereof are subject to strict requirements with respect to availability, safety and reliability. Therefore, a quick-closing valve usually has a working cylinder that is lifted by a hydraulic pressure against a preloading element, e.g., a spring, and accordingly actively opens the quick-closing valve as long as the hydraulic pressure overcomes the preloading of the preloading element. In order to close the quick-closing valve, this hydraulic pressure is reduced as quickly as possible, for example, guided into a tank. The pressureless working cylinder is forced into the closed position of the quick-closing valve by the preloading element.

For this purpose, DE 10 2004 042 891 B3 proposes a control device having a cartridge valve for reducing the hydraulic pressure opening the quick-closing valve and a relief valve control valve arrangement which actuates this cartridge valve and which has three solenoid valves in which a 2-out-of-3 (2oo3) voting system is implemented, i.e., they are hydraulically connected to the relief valve in such a way that the relief valve does not close the quick-closing valve unless at least two of the three valves of the relief valve control valve arrangement are switched to a quick-closing position. Advantageously, unnecessary quick closing due to a single defective valve of the relief valve control valve arrangement can be avoided in this way, and these valves can be tested individually during operation.

DE 2 254 250 A suggests a 2-out-of-3 voting with respect to the monitoring channels of a control device for a quick-closing valve of a steam turbine in order to increase monitoring reliability.

These control devices have the drawback that the possibilities for checking or testing the triggering actuating system and the quick-closing valve are limited.

### SUMMARY OF THE INVENTION

An object of the present invention is to improve the availability, safety and reliability of a quick-closing valve for a steam turbine.

A control device according to one embodiment of the invention for a quick-closing valve of a steam turbine has a relief valve for reducing a hydraulic pressure opening the quick-closing valve. In particular the quick-closing valve can have a hydraulically actuated working cylinder which can be moved actively into an open position by corresponding hydraulic pressure against a preloading element, for example, a tension spring or compression spring, and which closes the quick-closing valve when the hydraulic pressure is sufficiently reduced. This reduction in hydraulic pressure and, hence, the closing of the quick-closing valve can be carried out by means of the relief valve which can comprise, for example, one or more cartridge valves and/or globe valves.

To control this relief valve, a relief valve control valve arrangement is provided and has three or more valves which are hydraulically interconnected with the relief valve in such a way that the relief valve does not close the quick-closing valve unless at least two valves of the relief valve control valve arrangement are switched to a quick-closing position, i.e., implement a 2-out-of-3 voting.

According to one embodiment of the invention, a test control valve arrangement is provided in addition and is preferably constructed so as to be independent from the relief valve control valve arrangement and can reduce and increase the hydraulic pressure which opens the quick-closing valve against the preloading element.

Therefore, by this additional test control valve arrangement, a test of the quick-closing valve, particularly a partial stroke test, can also be carried out when the relief valve is closed in that, starting with the quick-closing valve fully opened or open in a normal operating position, the hydraulic pressure is initially reduced in such a way that the quick-closing valve closes completely or at least partially in that, for example, the working cylinder carries out a full or partial strike. The hydraulic pressure is then increased again and the quick-closing valve is accordingly moved back into its starting position.

By this test, which can be performed before, during and/or after the operation of the turbine, the function of the quick-closing valve can be tested independently from the relief valve control valve arrangement and, a stiffness or jamming due to scaling or the like, can accordingly be detected. In a preferred embodiment, the test control valve arrangement further comprises a possible redundancy, independent from the relief valve, for reducing the hydraulic pressure and, therefore, for closing the quick-closing valve, albeit this is carried out more slowly than by the relief valve. In case of a quick closing, the relief valve and the test control valve arrangement can also advantageously be controlled in such a way that they both cut off the hydraulic pressure so that the quick-closing valve is closed even faster.

The test control valve arrangement preferably has one or more first control valves and/or one or more second control valves. The connection of the relief valve to a pressure source, for example, a hydraulic pressure reservoir, a pump, or the like, and the connection of the relief valve to a pressure sink, for example, one or more tanks, can both be carried out by the first and/or second control valves.

The first control valve and second control valve can be connected in parallel or in series, and a throttle, preferably an adjustable throttle, can be connected upstream of the first control valve and second control valve in the connection to the pressure source and/or to the quick-closing valve in order to reduce the hydraulic pressure acting upon the test control valve arrangement to a suitable level.

The relief valve control valve arrangement and the test control valve arrangement preferably form a constructional unit. In particular, these two subunits can form a compact block and can be fastened to one another and/or to a support. This facilitates assembly of the whole control device and reduces the required installation space.

Valves of the relief valve control valve arrangement and/or of the test control valve arrangement are preferably constructed as 4/2-way solenoid valves, i.e., valves with four ports which can be switched into two positions by electromagnets which preferably act in opposition to a preloading element. Valves of the relief valve control valve arrangement preferably connect the relief valve to a pressure sink or sever it from a pressure source when they are not energized, i.e., open the relief valve in the de-energized state. Similarly, a first control valve and/or a second control valve of the test control valve arrangement preferably connect(s) the quick-closing valve to the pressure sink while cutting it off from the pressure source when they are energized, i.e., close the quick-closing valve in the energized state. However, the reverse de-energized position is also possible.

The relief valve control valve arrangement and/or the test control valve arrangement preferably have/has an end position monitoring arrangement to determine whether the valves are operating properly, i.e., to determine whether or not they occupy the selected end position (open position or closed position).

In a preferred construction of the present invention, the control device has a relief valve control for detecting the speed of the steam turbine and switching the relief valve control valve arrangement into the quick closing position. This relief valve control advantageously comprises at least three speed detection units which are interconnected in such a way that the relief valve control valve arrangement is not switched into a quick closing position unless at least two speed detection units detect a speed of the steam turbine in excess of a predetermined threshold, i.e., implement 2-out-of-3 (2oo3) voting.

In so doing, the speed detection units can have synchronous-running monitoring for comparing the detected speeds, zero-speed monitoring and/or underspeed monitoring. The speed detection units preferably communicate with one another via a bus implementing the 2oo3 voting logic. External quick-closing commands, also called external tripping, can preferably also be issued to the relief valve control. These external quick-closing commands originate, for example, in a power monitor of the turbine, a coupling monitor, or the like, and lead to the switching of the relief valve control valve arrangement into the quick-closing position in the same way as when the predetermined threshold is exceeded by at least two detected speeds.

The speed detection units can each have one or more speed detection devices, for example, active speed sensors, and can be connected to them and/or valves of the relief valve control valve arrangement in a physically independent manner in order to increase reliability and safety.

For controlling the valves of the relief valve control valve arrangement for testing purposes and/or for controlling the test control valve arrangement for testing purposes, the relief valve control can have a test generator. The relief valve control valve arrangement and the test control valve arrangement can be controlled for testing purposes by a shared test generator, but each can also be provided with its own test generator which can preferably be implemented in the relief valve control or can be separate from the latter.

The controlling of the valves of the relief valve control valve arrangement is preferably carried out in such a way that the valves of the relief valve control valve arrangement are individually switched into the quick-closing position for testing purposes in an alternating manner, particularly cyclically. Since the relief valve still does not close the quick-closing valve when only one valve of the relief valve control valve arrangement is switched to the quick-closing position due to the 2oo3 voting, this test can be carried out, e.g., periodically, also during operation of the turbine.

The test control valve arrangement is preferably controlled in such a way that the test control valve arrangement reduces the hydraulic pressure opening the quick-closing valve when the relief valve is closed and subsequently increases the hydraulic pressure again in order to carry out a full stroke test or partial stroke test. In particular, a partial stroke test can also be carried out during, preferably before and/or after, the operation of the turbine. One or more sensors which sense a displacement of the quick-closing valve, for example, a stroke of the working cylinder, are preferably provided for evaluating the test. At least two sensors are preferably provided on the same stroke height in order to distinguish between a sensor malfunction, which is identified by only one sensor signal, and a defective stroke, which is identified by signals from all of the sensors.

The test generator can be parameterized in order to adjust test conditions, for example, the time interval between two tests, the partial stroke height, or the like.

The test generator preferably carries out testing of the quick-closing valve by controlling the test control valve arrangement and/or carries out testing of the relief valve control valve arrangement automatically, for example, after a given number of operating hours, a given quantity of other tests, or the like. For this purpose, it can have an operating hours counter and/or a start counter.

### BRIEF DESCRIPTION OF DRAWINGS

Other advantages and features are indicated in the dependent claims and the embodiment example. In the partially schematic drawing:

FIG. 1 is a control device for a quick-closing valve of a steam turbine according to one embodiment of the present invention.

### DETAILED DESCRIPTION OF THE DRAWINGS

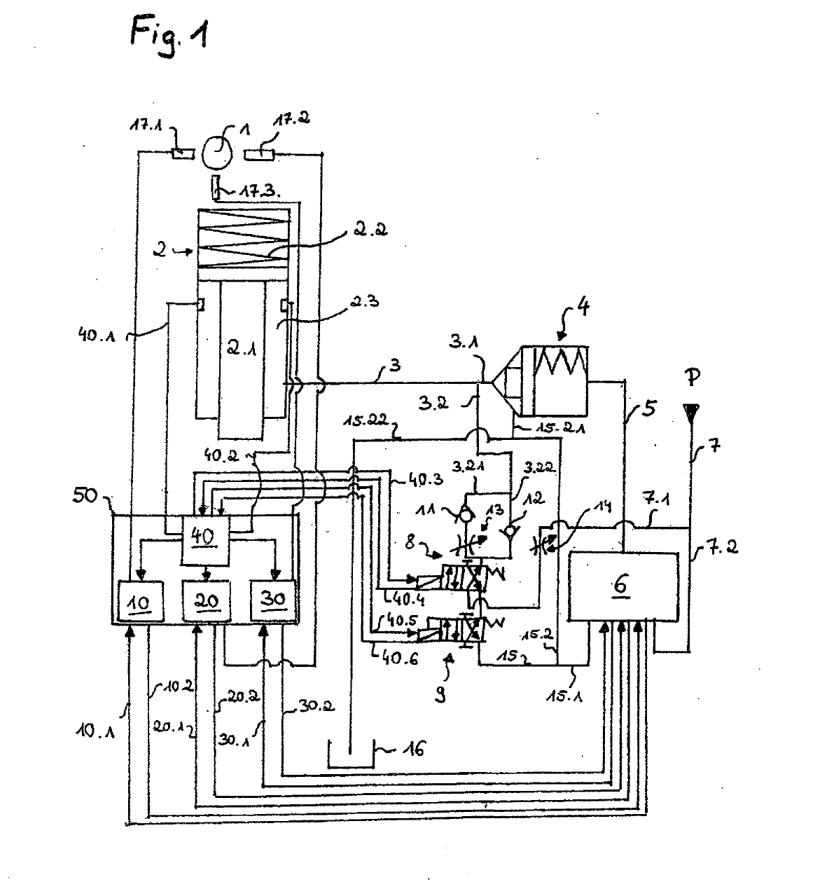

FIG. 1 is a partially schematic diagram showing a control device for a quick-closing valve of a steam turbine according to one embodiment of the present invention in the form of a hydraulics and data diagram.

The speed of a rotor 1 of a steam turbine is detected by three independent speed sensors 17.1 to 17.3. If a speed detected by a sensor 17.N exceeds a predetermined threshold, a speed detection unit 10, 20, or 30 connected with a respective one of the sensors 17.N sends a switching command via a control line 10.2, 20.2 or 30.2 to a 4/2-way solenoid valve in a relief valve control valve arrangement 6.

This is not shown or described in more detail because reference is had for this purpose to DE 10 2004 042 891 B3, whose disclosure in this regard is expressly incorporated in the subject matter of the present application by reference. Generally, the three 4/2-way solenoid valves of the relief valve control valve arrangement 6 are hydraulically linked in such a way that a so-called 2-out-of-3 voting results.

When at least two of the three solenoid valves of the relief valve control valve arrangement 6 are not switched to a quick-closing position by control commands of the speed detection units 10, 20 or 30, the connection of a cartridge relief valve 4 to a pressure source P via passages 5, 7.2 is severed, while the relief valve 4 communicates with a pressure sink 16 via passages 5, 15.1, 15.2, 15.22.

Accordingly, the hydraulic pressure in a work space 2.3 of a quick-closing valve 2 opens the cartridge valve 4, its working piston 2.1 moves out under the force of a preloaded disk spring 2.2 (downward with reference to FIG. 1) and, in so doing, pushes hydraulic liquid out of the work space 2.3 into the tank 16 via passages 3, 3.1, the opened valve 4, and passages 15.21, 15.22 and closes the quick-closing valve in such a way that a supply of steam to the steam turbine is interrupted and the rotor 1 is prevented from exceeding a permissible maximum speed.

To check the relief valve control valve arrangement 6, a test generator 40 controls the individual speed detection units 10, 20 an 30 cyclically in such a way that they alternately switch the associated solenoid valve of the relief valve control valve arrangement 6 to the quick-closing position. End position sensors in these magnets (not shown) report via data lines 10.1, 20.1 or 30.1 about whether or not the respective valve is functioning properly.

To carry out a partial stroke test, the test generator 40 triggers two additional control valves in the form of 4/2-way solenoid valves 8, 9 via control lines 40.3, 40.5 in such a way that the control valves 8, 9 of the test control valve arrangement are simultaneously switched proceeding from the operating position shown in FIG. 1 and connects the work space 2.3 to the tank 16 via passages 3, 3.2 (i.e., bypassing the relief valve 4), 3.21, a check valve 11, an adjustable throttle 13, the control valves 8, 9, which are now energized, and passages 15, 15.2, 15.22. Corresponding to the triggering of the first control valve 8 and second control valve 9 and the adjustment of the throttle 13, the hydraulic pressure is reduced in the work space 2.3, and the working piston 2.1 carries out a partial stroke (downward in FIG. 1) which is detected by sensors 40.1, 40.2 and transmitted to the test generator.

After achieving the desired partial stroke which demonstrates the viability of the quick-closing valve 2 or restores or improves its functionality by the removal of scales or the like, the first control valve 8 and the second control valve 9 of the test control valve arrangement are switched again into the operating position shown in FIG. 1 so that the pressure source P is connected to the work space 2.3 via passages 7, 7.1, an adjustable throttle 14, the first control valve 8 and second control valve 9, a check valve 12, and passages 3.22, 3.2, 3, so that the hydraulic pressure in this work space 2.3 is increased, drives the working piston 2.1 against the preloading of the disk spring 2.2, and accordingly opens the quick-closing valve again until the test generator 40 determines by means of the sensors 40.1, 40.2 that the partial stroke has been canceled. The end positions of the first control valve 8 and second control valve 9 are also monitored by end position sensors and are reported to the test generator via data lines 40.4, 40.6.

The relief valve control valve arrangement 6 and the test control valve arrangement 8, 9 are assembled in a compact block to form a constructional unit. In so doing, the first control valve 8 and the second control valve 9 preceded by the adjustable throttle 13 are connected in series in the manner shown in FIG. 1. They are controlled in predetermined time intervals by the test generator 40 to carry out a partial stroke test as was described above. The 2oo3 voting valve block 6, 8, 9 can also be formed in an explosion protection construction.

The two subunits comprising the relief valve control valve arrangement 6 and the test control valve arrangement 8, 9 are controlled by the speed detection units 10, 20, 30 and the test generator 40, respectively, which can be assembled to form an overspeed detection system 50.

The overspeed detection system 50 can have additional relay subassemblies (not shown), particularly for implementing dual circuits with 2oo3 voting for switching off additional consumers.

The 2oo3 voting is constructed with a 3-channel redundancy. Tripping or quick-closing messages or commands are compared in a 2oo3 voting logic and the majority consensus is outputted (not shown in the drawing) in triplicate in a fail-safe relay circuit with positively guided contacts.

Three 2oo3 circuits which open when triggered are available on the outer side for tripping or triggering a quick-closing. The additional dual circuits mentioned above are also available.

One or more of the speed detection units 10, 20, 30 preferably has a transmitter circuit monitor, a transmitter signal monitor, a transmitter signal redirect, an overspeed threshold, an underspeed threshold, a zero-speed detector with relay output, control inputs for external tripping, and a trip line monitor or 2oo3 solenoid valve monitor, an error report device, and/or means for sensing the rotating direction.

A keypad (not shown) for operating and parameterizing, a five-digit display for displaying the current speed and for an error message display, and four LEDs for a status display are located on the front of one or more of the speed detection units 10, 20, 30. Each speed detection unit 10, 20, 30 has a front Profibus DP interface (not shown) for data exchange with a Profibus Master.

The test generator 40 is outfitted with automatic, cyclical test routines for overspeed, 2oo3 logic of the 2oo3 valve block, and the partial stroke test. A keypad for parameterizing, a display for displaying the test speed, LEDs for displaying the status, and a Profibus interface for data exchange with a Profibus Master (not shown) are located on the front of the generator housing.

A tripping closure or quick-closing can be stored in a fail-safe control in a manner not shown in more detail. A trip reset can be realized in this fail-safe control. The system preferably adopts the GOOD state automatically when there is no internal or external trip condition. A fail-safe control is advantageous for the construction of the overspeed protection.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A control device for a quick-closing valve of a steam turbine comprising:
a relief valve for reducing a hydraulic pressure thereby opening the quick-closing valve;
a relief valve control valve arrangement comprising at least three valves that are hydraulically interconnected with the relief valve such that the relief valve does not close the quick-closing valve unless at least two valves of the relief valve control valve arrangement are switched in a quick-closing position; and
a test control valve arrangement configured to selectively reduce and increase the hydraulic pressure that opens the quick-closing valve when the relief valve is closed.

18. The control device according to claim 17, wherein the test control valve arrangement comprises a first control valve and a second control valve.

19. The control device according to claim 18, wherein the first control valve and the second control valve are connected in series.

20. The control device according to claim 18, wherein a throttle is arranged between the test control valve arrangement and one of a pressure source and the quick-closing valve.

21. The control device according to claim 17, wherein the relief valve control valve arrangement and the test control valve arrangement form a constructional unit.

22. The control device according to claim 17, wherein at least one valve of the relief valve control valve arrangement and at least one valve of the test control valve arrangement is a 4/2-way solenoid valve.

23. The control device according to claim 17, wherein at least one of the relief valve control valve arrangement and the test control valve arrangement has an end position monitor.

24. The control device according to claim 17, wherein the relief valve control is configured to detect a speed of the steam turbine and switching the relief valve control valve arrangement into the quick closing position.

25. The control device according to claim 24, wherein the relief valve control comprises at least three speed detection units that are interconnected such that the relief valve control valve arrangement is not switched into a quick closing position unless at least two speed detection units detect a speed of the steam turbine in excess of a predetermined threshold.

26. The control device according to claim 25, wherein the speed detection units each comprise at least one of:
a synchronous-running monitor,
a zero-speed monitor, and
an underspeed monitor.

27. The control device according to claim 25, wherein the connections of the relief valve control to the at least one of the at least three speed detection devices and to at least three valves of the relief valve control valve arrangement are formed so as to be physically independent.

28. The control device according to claim 17, wherein the relief valve control comprises a test generator for controlling at least one of the valves of the relief valve control valve arrangement and the test control valve arrangement for testing purposes.

29. The control device according to claim 28, wherein the test generator is parameterized and comprises at least one of an operation hours counter and a start counter.

30. A system comprising:
a steam turbine;
a quick-closing valve for the steam turbine; and
a control device for the quick-closing valve comprising:
a relief valve for reducing a hydraulic pressure opening the quick-closing valve;
a relief valve control valve arrangement comprising at least three valves that are hydraulically interconnected with the relief valve such that the relief valve does not close the quick-closing valve unless at least two valves of the relief valve control valve arrangement are switched in a quick-closing position; and
a test control valve arrangement configured to selectively reduce and increasing the hydraulic pressure that opens the quick-closing valve when the relief valve is closed.

31. A method for carrying out a partial stroke test of a quick-closing valve for a steam turbine comprising a control device for the quick-closing valve comprising:
a relief valve for reducing a hydraulic pressure opening the quick-closing valve;
a relief valve control valve arrangement comprising at least three valves that are hydraulically interconnected with the relief valve such that the relief valve does not close the quick-closing valve unless at least two valves of the relief valve control valve arrangement are switched in a quick-closing position; and
a test control valve arrangement configured to selectively reduce and increasing the hydraulic pressure that opens the quick-closing valve when the relief valve is closed, the method comprising:
reducing the hydraulic pressure; and
subsequently increasing the hydraulic pressure opening the quick-closing valve when the relief valve is closed.

32. The method according to claim 31, wherein at least three valves of the relief valve control valve arrangement are alternately switched individually into the quick closing position for test purposes.

33. The control device according to claim 20, wherein the throttle is an adjustable throttle.
